(19) United States
(12) Patent Application Publication
(10) Pub. No.: US 2009/0180007 A1
(43) Pub. Date: Jul. 16, 2009

(54) Digital image processing apparatus and method of controlling the same

(75) Inventor: Sung-ho Eun, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/291,417

(22) Filed: Nov. 10, 2008

(30) Foreign Application Priority Data
Jan. 14, 2008 (KR) 10-2008-0003921

(51) Int. Cl. H04N 5/76

(52) U.S. Cl. 348/231.99

(57) ABSTRACT

A digital image processing apparatus and a method of controlling the same. The digital image processing apparatus maintains a quick-view mode when it takes longer for a user to confirm a capture image than the preset time provided by the quick view mode of the apparatus. The digital image processing apparatus captures an image and automatically displays the captured image for a predetermined time. The apparatus includes a digital signal processing unit for determining if the display of the captured image is to be maintained, and controlling the digital image processing apparatus to maintain the display of the captured image until a display end event occurs.

### CROSS-REFERENCE TO RELATED PATENT APPLICATION

This application claims the benefit of Korean Patent Application No. 10-2008-0003921, filed on Jan. 14, 2008, in the Korean Intellectual Property Office, the entire contents of which is incorporated herein by reference.

### BACKGROUND OF THE INVENTION

1. Field of the Invention

The present invention relates to a digital image processing apparatus, and a method of controlling the same. More particularly, the present invention relates to a digital image processing apparatus which maintains a quick view when it takes a large time for a user to confirm a captured image, and a method of controlling the same.

2. Description of the Related Art

Conventionally, digital image processing apparatuses, such as digital cameras, personal digital assistants (PDAs), phone cameras, and personal computer (PC) cameras, process images captured with the apparatuses, or employ motion recognition sensors. A digital image processing apparatus receives a desired image through an imaging device, displays the received image on an image display device, stores the received image as an image file as selected by a user, and can print the stored image file.

A conventional digital image processing apparatus supports a quick-view function. Specifically, directly after an image is captured, the conventional digital image processing apparatus automatically displays the captured image for a predetermined time so as to enable a user to confirm the captured image, and then returns to a photographing mode. That is, the user may set a time (e.g., 0 seconds, 0.5 seconds, 1 second, or 3 seconds) to display a captured image for a quick view. In this case, once the set time for the quick view has elapsed, the conventional digital image processing apparatus can then be used to capture another image.

When the user sets the time for the quick view, the conventional digital image processing apparatus can automatically return to the photographing mode after the quick view is always displayed for the same set time. However, when an image is captured using the conventional digital image processing apparatus, the user may not be able to confirm the image for a time set for the quick view function. For example, when a self-timer function is set for a predetermined time so as to capture an image that is at a far distance from a camera or when an image that is at a far distance from the digital image processing apparatus (e.g., a camera) is to be captured by controlling the digital image processing apparatus using a remote controller, a quick view time may elapse before a user is able to confirm the image on the camera. Also, when the user captures an image using a self-shot function or in a dark place, the user needs a relatively longer time than the set time so as to confirm that the captured image is acceptable.

In this case, even though the user cannot confirm the captured image during the quick view, the digital image processing apparatus still returns to the photographic mode. Accordingly, the user is required to manually operate a button to enter into a playback mode to thus be able to confirm the captured image, and then needs to manually operate the button again to return to the photographing mode.

Therefore, since the same time for the quick view function is set in the conventional digital image processing apparatus, it is time consuming for a user to have to enter into the playback mode so as to be able to confirm a captured image. Also, entering into the playback mode as described above also requires too much manipulation of the buttons by the user so as to eventually return to the photographing mode, thereby precluding the user from maintaining the initial composition of an image to be captured.

### SUMMARY OF THE INVENTION

The present invention provides a digital image processing apparatus which maintains a quick-view mode when it takes a long time for a user to confirm a captured image.

Accordingly, an embodiment of the present invention provides a digital image processing apparatus that captures an image and automatically displays the captured image for a predetermined time. The apparatus includes a digital signal processing unit for determining if the display of the captured image is to be maintained and controlling the digital image processing apparatus to maintain the display of the captured image until a display end event occurs.

The digital signal processing unit may determine that the display of the captured image is to be maintained when the image is captured under a predetermined condition. The predetermined condition may include capturing the image in at least one of a self-shot mode, a self-timer mode, a remote controller mode, and capturing the image below a predetermined luminous intensity.

The display end event may be a display end signal input by a user. The display end event may occur when a predetermined time has elapsed after the image is captured under the predetermined condition. When the display end event occurs, the digital signal processing unit may return to a photographing mode.

Another embodiment of the present invention provides a method of controlling a digital image processing apparatus that captures an image and automatically displays the captured image for a predetermined time. The method includes inputting a shutter-release signal and generating and storing an image file, determining if the display of the captured image is to be maintained until a display end event occurs, displaying the generated and stored image file, and maintaining the display of the captured image until the display end event occurs.

The operation of determining if the display of the captured image is to be maintained until the display end event occurs may be performed depending on whether the image is captured under a predetermined condition. The predetermined condition may include capturing the image in at least one of a self-shot mode, a self-timer mode, a remote controller mode, and capturing the image below a predetermined luminous intensity. The operation of maintaining the display of the captured image until the display end event occurs may include a user inputting a display end signal. Also, the operation of maintaining the display of the captured image until the display end event occurs may include generating the display end event if a predetermined time has elapsed after the image is captured under the predetermined condition. After maintaining the display of the captured image until the display end event occurs, the method may further include returning to a photographing mode.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a front side and a top side of an example of a digital image processing apparatus, according to an embodiment of the present invention;

FIG. 2 is a view of a back side of the digital image processing apparatus shown in FIG. 1;

FIG. 3 is an exemplary block diagram of the digital image processing apparatus shown in FIGS. 1 and 2; and

FIG. 4 is a flowchart of an example of a method of controlling a digital image processing apparatus according to an embodiment of the present invention.

### DETAILED DESCRIPTION OF THE EMBODIMENTS

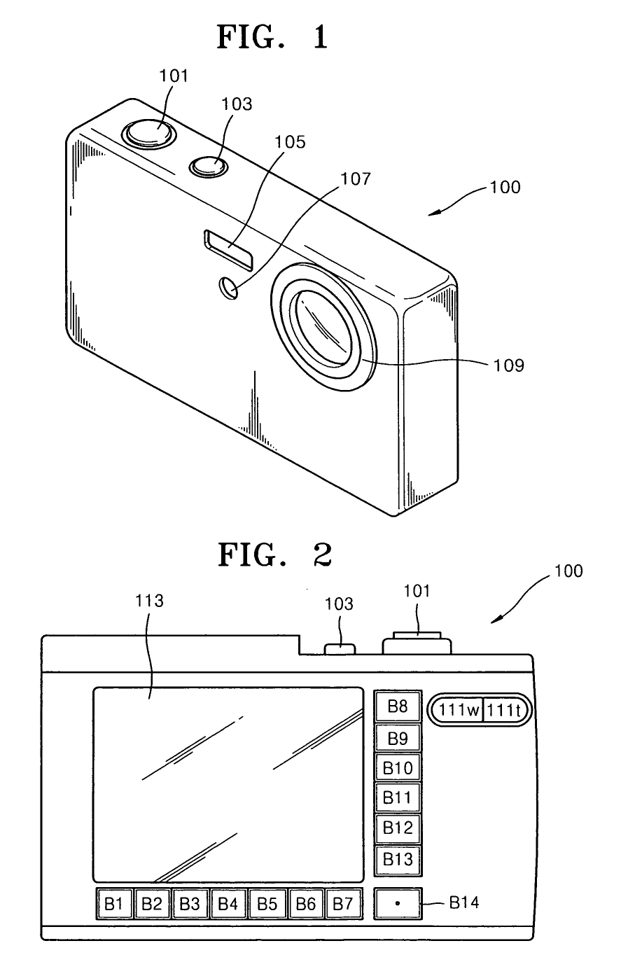

FIG. 1 is a perspective view of a front side and a top side of a digital image processing apparatus 100, according to an embodiment of the present invention. As shown, the digital image processing apparatus 100 includes a shutter-release button 101, a power button 103, a flash 105, a sub-light 107, and a lens 109.

When the power button 103 is pressed, power is supplied to the digital image processing apparatus 100 so that the digital image processing apparatus 100 can operate. In this state, that is, when the shutter-release button 101 is pressed by a user, a charge-coupled device (CCD) (or a film) is exposed to light for a predetermined time via an iris diaphragm (not shown) and the lens 109 so that an image of a subject to be captured is recorded on the CCD or film.

Additionally, when the shutter-release button 101 is pressed by the user, first and second image capturing signals are generated. When the shutter-release button 101 is half-pressed, the digital image processing apparatus 100 adjusts the focus and controls the amount of light entering the lens 109. When the focus is properly adjusted, a green light lights up on a display unit 113 (refer to FIG. 2). After the focus is adjusted as indicated by the lit green light on the display unit 113 and the amount of light that enters the lens 109 is controlled by half-pressing the first shutter-release button 101, the shutter-release button 101 can be fully pressed to photograph the subject.

The flash 105 is used to instantaneously illuminate the subject when the subject is being photographed in a dark place. Flash modes of the digital image processing apparatus 100 include an automatic mode, a forced flash mode, a flash-off mode, a red-eye reduction mode, and a slow-sync flash mode. The sub-light 107 supplies light to the subject in the case of a lack of light or for night photography, so that the digital image processing apparatus 100 can automatically adjusts its focus in a rapid and accurate way. The lens 109 receives light reflecting from the subject and processes an image of the subject.

FIG. 2 is a view of a back side of the digital image processing apparatus 100 shown in FIG. 1. As shown, the digital image processing apparatus 100 further includes a wide-angle zoom button 111w, a telephoto zoom button 111t, a display unit 113, and input buttons B1 to B14 (hereinafter, referred to as ‘buttons B1 to B14’), wherein each button may include a touch sensor (not shown) or a contact switch (not shown).

The wide-angle zoom button 111w or the telephoto zoom button 111t is pressed to respectively increase or decrease an angle of view, thereby changing the size of a selected region of the subject to be photographed. When the wide-angle zoom button 111w is pressed, the size of the selected region is reduced. When the telephoto zoom button 111t is pressed, the size of the selected region is enlarged.

The buttons B1 to B14 are arranged in a column and a row adjacent to a side and bottom of the display unit 113, respectively. If each of the buttons B1 to B14 includes a touch sensor, each of the buttons B1 to B7 arranged in the row or each of the buttons B8 to B14 arranged in the column can be touched to move the buttons B1 to B14 vertically, or horizontally, so that an arbitrary value (e.g., color or brightness) may be selected out of main menu icons or one of the sub-menu icons included in the main menu icons may be enabled.

If each of the buttons B1 to B14 includes a contact switch, a main menu icon and a sub-menu icon can be directly selected to perform a desired function. Thus, the operating force for the touch sensors is smaller than that for the contact switches.

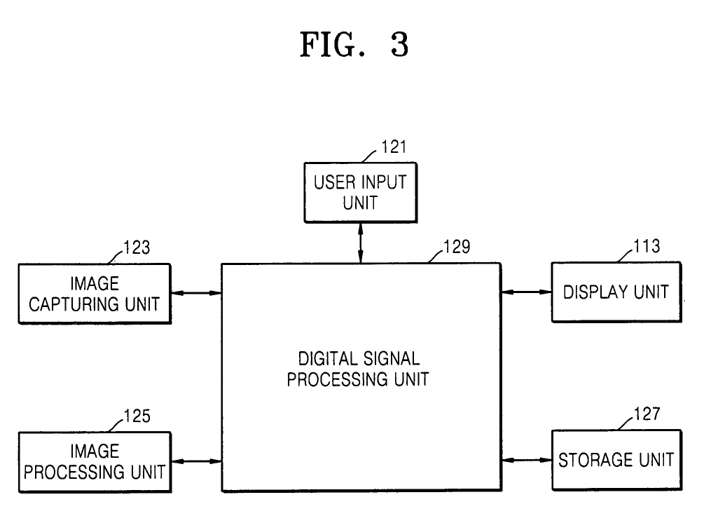

FIG. 3 is an exemplary block diagram of the digital image processing apparatus 100 shown in FIGS. 1 and 2. As shown, the digital image processing apparatus 100 includes the display unit 113, a user input unit 121, an image capturing unit 123, an image processing unit 125, a storage unit 127, and a digital signal processing unit 129.

The user input unit 121 includes the shutter release button 101, the power button 103, the wide-angle zoom button 111w and the telephoto zoom button 111t, and the buttons B1 to B14. The shutter-release button 101 is operated to expose a CCD (or a film) to light for a predetermined time. The power button 103 is pressed to supply power to the digital image processing apparatus 100. The wide-angle zoom button 111w or the telephoto zoom button 111t is pressed to increase or decrease an angle of view. The buttons B1 to B14 are arranged in the row and the column respectively adjacent to the bottom and side of the display unit 113. Each of the buttons B1 to B14 may include a touch sensor (not shown) or a contact switch (not shown).

The image capturing unit 123 includes, although not shown, a shutter, a lens, an iris diaphragm, the CCD, and an analog-to-digital converter (ADC). The shutter is a component that controls the amount of light that enters the lens and the iris diaphragm, where the lens receives light reflecting from a subject to be photographed and processes an image of the subject. In this case, the amount of light is controlled according to an aperture of the iris diaphragm, which is regulated by the digital signal processing unit 129. The CCD accumulates light received via the lens and outputs an image on the display unit 113 according to the amount of accumulated light in response to a vertical synchronizing signal. The CCD converts light reflected from a subject to be photographed into an electric signal. In order to obtain a color image using the CCD, a color filter is included in the digital image processing apparatus 100 of the present invention, and such color filter may be a color filter array (CFA). The CFA includes regularly arranged pixels each allowing only single-color light to pass therethrough, and may have various shapes according to the type of the arrangement of the pixels. The ADC converts an analog image signal output from the CCD into a digital signal.

The image processing unit 125 processes raw digital data so as to display the data. The image processing unit 125 removes a black level caused by dark current generated in the CCD and CFA, which are sensitive to temperature variations. The image processing unit 125 gamma encodes data in conformity with non-linearity of the human eyesight. The image processing unit 125 converts a Bayer pattern embodied by an RGRG line and a GBGB line of the gamma encoded data into an RGB line by using CFA interpolation. The image processing unit 125 converts an interpolated RGB signal into a YUV signal, performs an edge compensation process of filtering a Y signal by using a high pass filter (HPF) so as to process an image clearly, performs a color correction process of correcting color values of U and V signals by using a normal color coordinate system, and eliminates noise from Y, U, and V signals. The image processing unit 125 compresses and processes the Y, U, and V signals, from which noise is eliminated, to generate a joint photographic coding experts group (JPEG) file that is to be displayed on the display unit 113 and stored in the storage unit 127. The above-described operations of the image processing unit 125 are controlled by the digital signal processing unit 129.

The digital signal processing unit 129 determines if it takes a longer time than the set time of the quick view so as to confirm a captured image, that is, if a quick view is to be maintained for a longer time than the set time of the quick view. Thus, when it is determined that the quick view is to be maintained for a longer time than the set time of the quick view, the digital signal processing unit 129 controls so as to maintain the quick view until a quick-view end event occurs.

Conventionally, when a user sets a quick-view mode, a digital image processing apparatus always displays a quick view for the same set period of time and automatically returns to a photographing mode once the same set period of time has elapsed. In this case, however, the user may not confirm the captured image for a predetermined time set for the quick-view mode. In this case, since the digital image processing apparatus returns to the photographing mode without allowing confirming of the captured image during the quick view, the user needs to manually operate a button to enter into a playback mode and thus then be able to confirm the captured image, and then manually operate the button again to return to the photographing mode. Since the same time is set for the quick view in the digital image processing apparatus, when a longer time than the same set time is required for the user to confirm the captured image, it inconveniences the user to have to enter into the playback mode.

In order to address this problem, a digital image processing apparatus according to an embodiment of the present invention determines if a quick-view mode is to be maintained longer than a set time, and maintains the quick-view mode until a quick-view end event occurs according to the determination result. Specifically, the user may set a time for the quick-view mode. In other words, the user may set a time (e.g., 0 seconds, 0.5 seconds, 1 second, or 3 seconds) to display the quick view. In addition to the quick-view mode, the digital image processing apparatus according to the present invention may further include an auto mode. When the user sets the auto mode, the digital image processing apparatus determines if an image of a subject is captured under a predetermined condition where the quick-view mode is to be maintained, as compared with a digital image processing apparatus that conventionally always displays the quick view for the same set time and automatically returns to a photographing mode once the same set time has elapsed. Thus, when it is determined that the image of the subject is captured under the predetermined condition where the quick-view mode is to be maintained, the quick-view mode is maintained until the quick-view end event occurs.

When the user sets the auto mode and presses the shutter-release button 101, an image file is generated and stored. Thereafter, the digital signal processing unit 129 determines if the image of the subject is captured under a predetermined condition where the quick-view mode is to be maintained.

For example, when a self-timer function is set for predetermined time so as to capture an image at a far distance from the digital image processing apparatus (e.g., a camera) or when an image that is at a far distance from the digital image processing apparatus is to be captured by controlling the digital image processing apparatus using a remote controller, a time set for the quick-mode may elapse before the user confirms the captured image on the camera. Accordingly, the digital signal processing unit 129 determines if photographing is being performed using the self-timer function or the remote controller.

Also, when the user captures an image using a self-shot function or in a dark place, the user needs a relatively longer time than the set time of the quick view so as to confirm that the captured image is acceptable. Accordingly, the digital signal processing unit 129 determines if the image is captured using the self-shot function or below a predetermined luminous intensity. Thus, when it is determined that the image is captured using the self-shot function, the self-timer, the remote controller, or below the predetermined luminous intensity, the digital signal processing unit 129 controls the digital image processing apparatus so as to maintain the quick-view mode until the quick-view end event occurs.

The quick-view end event may be a quick-view end signal input by the user. Specifically, while the generated and stored image file is being displayed on the display unit 113 in the quick-view mode, the user can confirm that the captured image is acceptable. Thereafter, the user may press, for example, the shutter-release button 101 to return to a photographing mode. As a result, the digital signal processing unit 129 may enable the digital image processing apparatus to end the quick-view mode and return to the photographing mode.

Alternatively, the quick-view end event may occur when a predetermined time has elapsed after the image is captured using the self-shot function, the self-timer, the remote controller, or below the predetermined luminous intensity. That is, the digital signal processing unit 129 may previously set a sufficient time (e.g., 10 seconds, 30 seconds, or 1 minute) to confirm the generated and stored image file, and control the digital image processing apparatus to exit the quick-view mode after the set time has elapsed and thus then enter the photographing mode again. In other words, when the image of the subject is captured under the predetermined condition where the quick-view mode is to be maintained, the digital signal processing unit 129 controls the digital image processing apparatus to display the quick view for a longer time than the set time.

As described above, when the quick-view end event occurs, the digital signal processing unit 129 controls the digital image processing apparatus to exit the quick-view mode and return to the photographing mode. According to an embodiment of the present invention, when it takes a longer time than the set time of the quick view so as to confirm the captured image, the digital image processing apparatus can maintain the quick-view mode, thereby improving the convenience to the user.

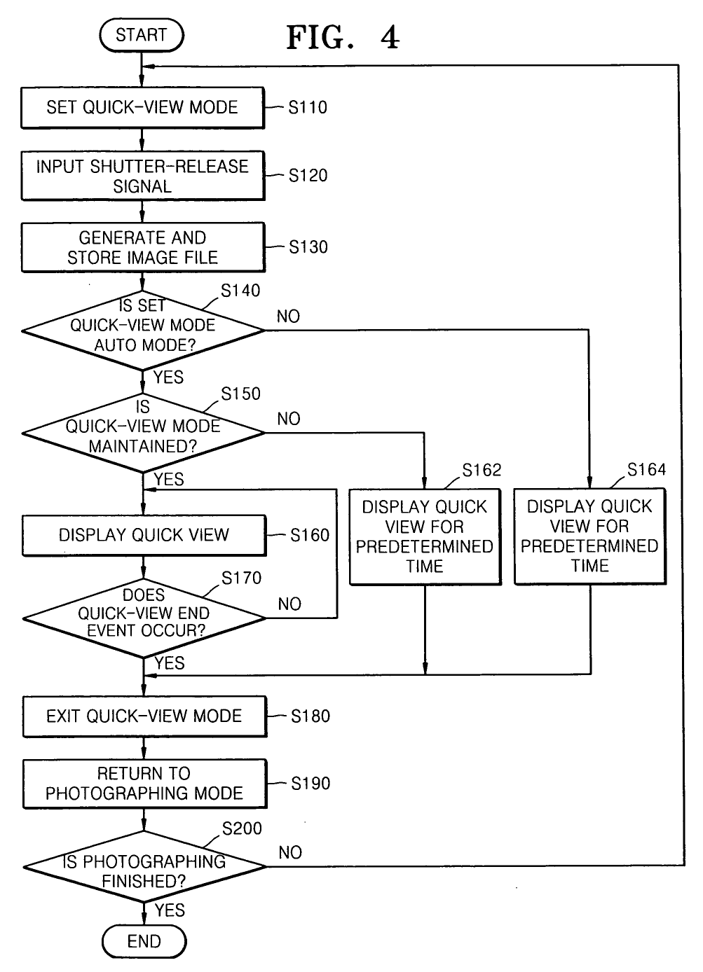

Hereinafter, an example of a method of controlling a digital image processing apparatus according to an embodiment of the present invention will be described in detail with reference to FIG. 4. In the present embodiment, an algorithm for operating the digital image processing apparatus may be performed in the digital signal processing unit 129 by the aid of peripheral components of the digital image processing apparatus 100, if necessary.

Referring to FIG. 4, initially, a quick-view mode is set in operation S110. In operation S120, a shutter-release signal is input in operation S120. An image file is generated and stored in operation S130. It is determined if the set quick-view mode is an auto mode or not in operation S140. It is determined if the quick-view mode is to be maintained until a quick-view end event occurs in operation S150. A quick view is displayed in operation S160. It is determined if the quick-view end event occurs or not in operation S170. The quick-view mode is finished in operation S180. The digital image processing apparatus returns to a photographing mode in operation S190.

To begin with, a user sets the quick-view mode in operation S110. Specifically, the user may set a time (e.g., 0 seconds, 0.5 seconds, 1 second, or 3 seconds) to display the quick view. In addition to the quick-view mode, the digital image processing apparatus may further provide an auto mode. When the user sets the auto mode, the digital image processing apparatus determines if an image of a subject is captured under a predetermined condition where the quick-view mode is to be maintained, as compared with a digital image processing apparatus that conventionally always displays the quick view for the same set time and automatically returns to a photographing mode once the same set time has elapsed. Thus, when it is determined that the image of the subject is captured under the predetermined condition where the quick-view mode is to be maintained, the quick-view mode is maintained until the quick-view end event occurs.

Next, the shutter-release signal is input in operation S120, and the image file is generated and stored in operation S130. That is, the digital signal processing unit 129 receives the shutter-release signal, controls the image processing unit 125, generates a captured image as a JPEG image file, and then stores the JPEG image file in the storage unit 127.

Subsequently, the digital signal processing unit 129 determines if the quick-view mode is the auto mode or not in operation S140. As a result, if it is determined that the quick-view mode is not the auto mode in operation S140, the digital image processing apparatus displays the quick view for a predetermined time (e.g., 0 seconds, 0.5 seconds, 1 second, or 3 seconds) and then returns to the photographing mode in operation S164.

Conversely, when it is determined that the quick-view mode is the auto mode in operation S140, the digital signal processing unit 129 determines if the quick-view mode is to be maintained until the quick-view end event occurs in operation S150. As a result, when it is determined that the quick-view mode is not to be maintained until the quick-view end event occurs in operation S150, the digital image processing apparatus displays the quick view for a predetermined time (e.g., 0 seconds, 0.5 seconds, 1 second, or 3 seconds) and then returns to the photographing mode in operation S162.

Conversely, when it is determined that the quick-view mode is to be maintained until the quick-view end event occurs, the digital signal processing unit 129 displays the quick view until the quick-view end event occurs in operation S160. Specifically, when a self-timer function is set for a predetermined time so as to capture an image at a far distance from the digital image processing apparatus (e.g., a camera) or when an image that is at a far distance from the digital image processing apparatus is to be captured by controlling the digital image processing apparatus using a remote controller, a time set for the quick-mode may elapse before the user confirms that the captured image on the camera is acceptable. Accordingly, the digital signal processing unit 129 determines if photographing is being performed using the self-timer function or the remote controller.

Also, when the user captures an image using a self-shot function or in a dark place, the user needs a relatively longer time than the set time of the quick view so as to confirm that the captured image is acceptable. Accordingly, the digital signal processing unit 129 determines if the image is captured using the self-shot function or below a predetermined luminous intensity.

Thus, when it is determined that the image is captured using the self-shot function, the self-timer, the remote controller, or below the predetermined luminous intensity, the digital signal processing unit 129 controls the digital image processing apparatus to maintain the quick-view mode until the quick-view end event occurs. While the quick view is being displayed on the display unit 113, the digital signal processing unit 129 determines if the quick-view end event occurs in operation S170.

The quick-view end event may be a quick-view end signal input by the user. Specifically, while the generated and stored image file is being displayed on the display unit 113 in the quick-view mode, the user sufficiently confirms the captured image. Thereafter, the user may press, for example, the shutter-release button 101 to return to a photographing mode.

Alternatively, the quick-view end event may occur when a predetermined time has elapsed after the image is captured using the self-shot function, the self-timer, the remote controller, or below the predetermined luminous intensity. That is, the digital signal processing unit 129 may previously set a sufficient time (e.g., 10 seconds, 30 seconds, or 1 minute) to confirm the generated and stored image file, and generate the quick-view end event after the elapse of the set time. In other words, when photographing is being performed under the predetermined condition where the quick-view mode is to be maintained, the digital signal processing unit 129 controls the digital image processing apparatus to be in the quick view for a longer time than the set time until the quick end event occurs.

When the quick-view end event occurs as described above, the digital signal processing unit 129 exits the quick-view mode in operation S180 and enters the photographing mode so as to photograph another image in operation S190. Finally, it is determined if photographing is finished in operation S200. If it is determined that the photographing is not finished in operation S200, the above-described operations are repeated.

According to the embodiments of the present invention as described above, when it takes a longer time than the set time of the quick view so as to confirm the captured image, the quick-view mode can be maintained for a longer time than the set time, thereby improving the convenience to the user.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A digital image processing apparatus that captures an image and automatically displays the captured image for a predetermined time, the apparatus comprising a digital signal processing unit for determining if the display of the captured image is to be maintained and controlling the digital image processing apparatus to maintain the display of the captured image until a display end event occurs.

2. The apparatus of claim 1, wherein the digital signal processing unit determines that the display of the captured image is to be maintained when the image is captured under a predetermined condition.

3. The apparatus of claim 2, wherein the predetermined condition includes capturing the image in at least one of a self-shot mode, a self-timer mode, a remote controller mode, and capturing the image below a predetermined luminous intensity.

4. The apparatus of claim 1, wherein the display end event is a display end signal input by a user.

5. The apparatus of claim 4, wherein the display end event signal is input in response to depression of a shutter-release button on the digital image processing apparatus by the user.

6. The apparatus of claim 2, wherein the display end event occurs when a predetermined time has elapsed after the image is captured under the predetermined condition.

7. The apparatus of claim 1, wherein when the display end event occurs, the digital signal processing unit returns to a photographing mode.

8. The apparatus of claim 1, wherein the digital signal processing unit determines if an automatic mode is set before determining if the display of the captured image is to be maintained.

9. The apparatus of claim 8, wherein when the digital signal processing unit determines that the automatic mode is not set, the digital signal processing unit displays the captured image for the predetermined time instead of performing the determining and controlling operations.

10. The apparatus of claim 8 wherein when the digital signal processing unit determines that the automatic mode is set and determines that the display of the captured image is not to be maintained, the digital signal processing unit displays the captured image for the predetermined time instead of performing the controlling operation.

11. A method of controlling a digital image processing apparatus that captures an image and automatically displays the captured image for a predetermined time, the method comprising:
inputting a shutter-release signal, and generating and storing an image file;
determining if the display of the captured image is to be maintained until a display end event occurs;
displaying the generated and stored image file; and
maintaining the display of the captured image until the display end event occurs.

12. The method of claim 11, wherein the determining of the display of the captured image is to be maintained until the display end event occurs is performed depending on whether the image is captured under a predetermined condition.

13. The method of claim 12, wherein the predetermined condition includes capturing the image in at least one of a self-shot mode, a self-timer mode, using a remote controller mode, and capturing the image below a predetermined luminous intensity.

14. The method of claim 11, wherein the maintaining of the display of the captured image until the display end event occurs comprises a user inputting a display end signal.

15. The method of claim 12, wherein the maintaining of the display of the captured image until the display end event occurs comprises generating the display end event if a predetermined time has elapsed after the image is captured under the predetermined condition.

16. The method of claim 11, after the maintaining of the display of the captured image until the display end event occurs, further comprising returning to a photographing mode.

17. The method of claim 11, wherein the display end event occurs in response to depression of a shutter-release button on the digital image processing apparatus by the user.

18. The method of claim 11, further comprising determining if an automatic mode is set before performing the step of determining if the display of the captured image is to be maintained, and before performing the displaying and maintaining steps.

19. The method of claim 18, wherein when the automatic mode determining step determines that the automatic mode is not set, displaying the captured image for the predetermined time instead of performing the determining, displaying and maintaining steps.

20. The method of claim 18, wherein when the automatic mode determining step determines that the automatic mode is set and the determining step determines that the display of the captured image is not to be maintained, displaying the captured image for the predetermined time instead of performing the displaying and maintaining steps.
